(19) United States
(12) Patent Application Publication
(10) Pub. No.: US 2026/0206110 A1
(43) Pub. Date: Jul. 16, 2026

(54) LIGHTING ADJUSTMENT CIRCUIT

(71) Applicant: Xiamen PVTECH Co., Ltd., Xiamen (CN)

(72) Inventors: DASHENG LI, Xiamen (CN); RONGTU LIU, Xiamen (CN); LIANGLIANG CAO, Xiamen (CN); FUXING LU, Xiamen (CN); CHUNMING LIU, Xiamen (CN)

(21) Appl. No.: 19/445,762

(22) Filed: Jan. 12, 2026

Related U.S. Application Data
(63) Continuation-in-part of application No. 19/399,746, filed on Nov. 25, 2025.

(30) Foreign Application Priority Data
Jan. 13, 2025 (CN) 202510049890.3
Aug. 14, 2025 (CN) 202511140526.4

(51) Int. Cl. H05B 45/20; F21V 23/04; H05B 45/345; H05B 47/155; F21Y 115/10

(52) U.S. Cl. CPC H05B 45/20; F21V 23/04; H05B 45/345; H05B 47/155; F21Y 2115/10

(57) ABSTRACT

The disclosure provides a lighting adjustment circuit, which includes a driving power source, a switching circuit, a low color temperature light source, and a high color temperature light source. The switching circuit is connected to the driving power source. The low color temperature light source is connected to the driving power source and the switching circuit. The high color temperature light source is connected to the driving power source and the switching circuit. The color temperature of the high color temperature light source is greater than the color temperature of the low color temperature light source. The switching circuit is switched to make the driving power source form three current loops to drive the low color temperature light source and the high color temperature light source.

### TECHNICAL FIELD

The disclosure relates to a lighting adjustment circuit, in particular to a lighting adjustment circuit having color temperature adjustment function.

### BACKGROUND

With the continuous development and innovation of technology, the functions and performance of light-emitting diode (LED) lighting devices have been significantly improved. Currently available LED lighting devices are not only capable of providing basic illumination functions, but also introduce color temperature adjustment technology, allowing users to flexibly change the color temperature of light according to different environmental requirements. However, due to limitations of circuit structures, such LED lighting devices with color temperature adjustment functions exhibit a noticeable bottleneck in improving luminous efficacy and are unable to satisfy actual requirements. Therefore, the luminous efficacy performance of currently available LED lighting devices still requires further improvement.

### SUMMARY

One embodiment of the disclosure provides a lighting adjustment circuit, which includes a driving power source, a switching circuit, a low color temperature light source, and a high color temperature light source. The switching circuit is connected to the driving power source. The low color temperature light source is connected to the driving power source and the switching circuit. The high color temperature light source is connected to the driving power source and the switching circuit. The color temperature of the high color temperature light source is greater than the color temperature of the low color temperature light source. The switching circuit is switched to make the driving power source form three current loops to drive the low color temperature light source and the high color temperature light source.

Through the above-described circuit design and the switching mechanism of the switching circuit, the driving power source is capable of forming three current loops to drive the low color temperature light source and the high color temperature light source, such that the lighting device can achieve more color temperature adjustment levels to meet the requirements of different applications.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a schematic view of a circuit structure of a multi-functional lighting adjustment circuit in accordance with a first embodiment of the disclosure.

FIG. 2 is a schematic view for illustrating a sliding switch of the multi-functional lighting adjustment circuit on a lighting device in accordance with the first embodiment of the disclosure.

FIG. 3 is a schematic view of a structure of a sliding switch in accordance with a second embodiment of the disclosure.

FIG. 4 is a schematic view for illustrating a sliding switch of a multi-functional lighting adjustment circuit on a lighting device in accordance with a third embodiment of the disclosure.

FIG. 5 is a schematic view for illustrating a sliding switch of a multi-functional lighting adjustment circuit on a lighting device in accordance with the fourth embodiment of the disclosure.

FIG. 6 is a schematic view for illustrating a sliding switch of a multi-functional lighting adjustment circuit on a lighting device in accordance with the fifth embodiment of the disclosure.

FIG. 7 is a mixed-light diagram of the multi-functional lighting adjustment circuit of the fifth embodiment of the disclosure.

FIG. 8 is a schematic view of a circuit structure of a lighting adjustment circuit having color temperature adjustment function in accordance with a sixth embodiment of the disclosure.

FIG. 9 is a circuit diagram of a switching circuit of a lighting adjustment circuit having color temperature adjustment function in accordance with a seventh embodiment of the disclosure.

FIG. 10 is a schematic view of a high color temperature mode of the switching circuit of the lighting adjustment circuit having color temperature adjustment function in accordance with the seventh embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

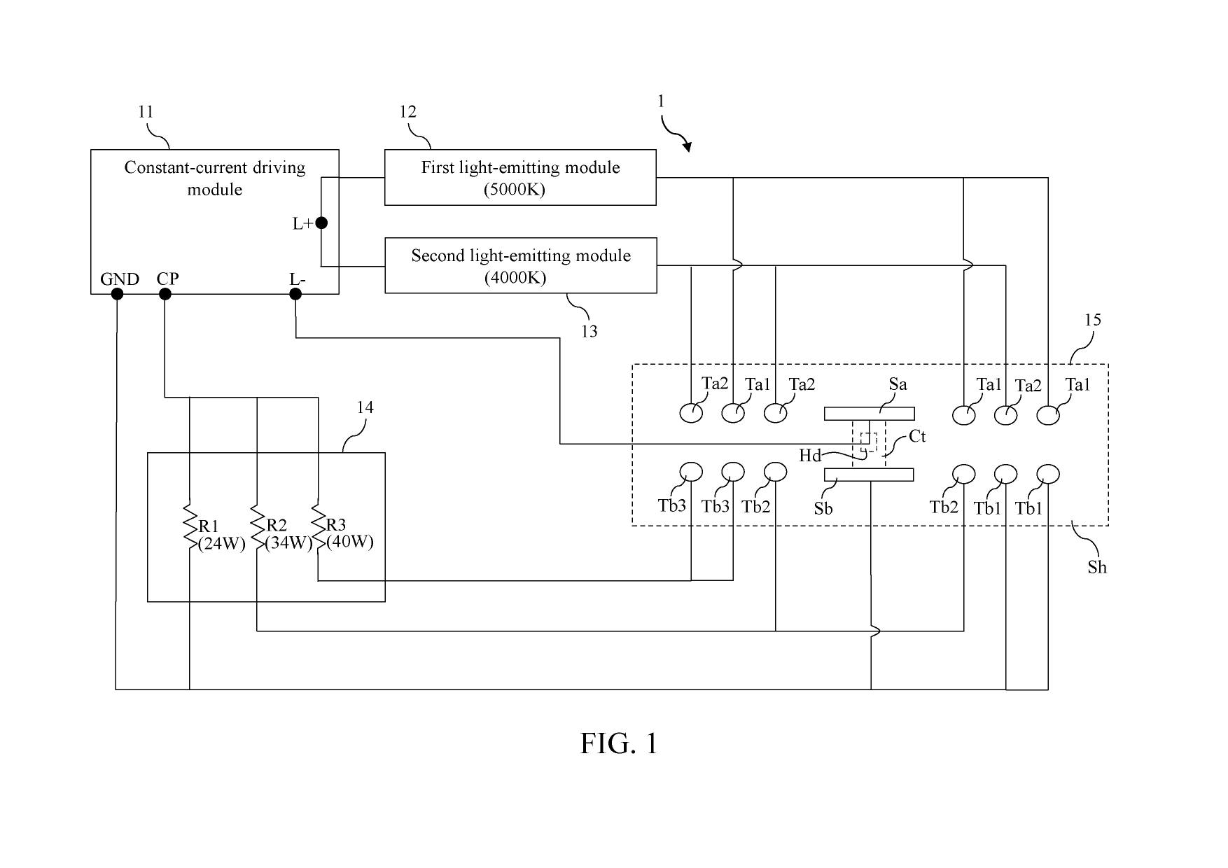

Please refer to FIG. 1, which is a schematic view of a circuit structure of a multi-functional lighting adjustment circuit in accordance with a first embodiment of the disclosure. As shown in FIG. 1, the lighting adjustment circuit 1 includes a constant-current driving module 11, a plurality of light-emitting modules, a power adjustment module 14, and a sliding switch 15.

The constant-current driving module 11 is connected to the light-emitting modules. In this embodiment, the light-emitting modules include a first light-emitting module 12 and a second light-emitting module 13. In another embodiment, the light-emitting modules may include three or more light-emitting modules, which can be adjusted according to actual requirements.

The sliding switch 15 is connected to the constant-current driving module 11 via the power adjustment module 14, and has a plurality of color temperature levels and a plurality of power levels.

The sliding switch 15 can be moved to simultaneously trigger one of the color temperature levels and one of the power levels. Accordingly, the constant-current driving module 11 can drive one or more of the light-emitting modules based on the triggered color temperature level and the triggered power level.

The following describes one circuit structure of the lighting adjustment circuit 1 in this embodiment, but is not limited to this circuit structure. The circuit structure of the lighting adjustment circuit 1 can be adjusted according to actual requirements.

The constant-current driving module 11 has a positive terminal L+, a negative terminal L-, a current detection terminal CP, and a ground terminal GND. The constant-current driving module 11 may be a light-emitting diode (LED) driver. In one embodiment, the constant-current driving module 11 is a non-isolated driver. In another embodiment, the constant-current driving module 11 may also be an isolated driver. In one embodiment, the current detection terminal CP is an ISP current detection terminal. In another embodiment, the current detection terminal CP may also be a DMIN PWM terminal or other similar components.

The first light-emitting module 12 is connected to the positive terminal L+ and has a first color temperature. In one embodiment, the first light-emitting module 12 is an LED module, which may be a light source board including a circuit board and a plurality of LEDs disposed on the circuit board. In another embodiment, the first light-emitting module 12 may also be an LED light strip or other similar components.

The second light-emitting module 13 is connected to the positive terminal L+ and has a second color temperature. The second color temperature is different from the first color temperature. In one embodiment, the second light-emitting module 13 is an LED module, which may be a light source board including a circuit board and multiple LEDs disposed on the circuit board. In another embodiment, the second light-emitting module 13 may also be an LED light strip or other similar components.

The sliding switch 14 has a plurality of upper terminals, a plurality of lower terminals, an upper sliding terminal Sa, a lower sliding terminal Sb, a connection portion Ct, a handle Hd, and a housing Sh. A portion of the upper terminals is connected to the first light-emitting module 12. The other portion of the upper terminals is connected to the second light-emitting module 13. A portion of the lower terminals is connected to the ground terminal GND. The upper sliding terminal Sa is connected to the lower sliding terminal Sb via the connection portion Ct, and the handle Hd is disposed on the connection portion Ct. The upper sliding terminal Sa is connected to the negative terminal L-, and the lower sliding terminal Sb is connected to the ground terminal GND. The upper terminals, the lower terminals, the upper sliding terminal Sa, the lower sliding terminal Sb, and the connection portion Ct are disposed in the housing Sh. A portion of the handle Hd is disposed inside the housing Sh, and the other portion of the handle Hd protrudes from the housing Sh. Thus, the user can operate the handle Hd to simultaneously move the upper sliding terminal Sa and the lower sliding terminal Sb. In this embodiment, the upper terminals include a plurality of first upper terminals Ta1 and a plurality of second upper terminals Ta2. The first upper terminals Ta1 are connected to the first light-emitting module 12, and the second upper terminals Ta2 are connected to the second light-emitting module 13. The first upper terminals Ta1 and the second upper terminals Tb1 are arranged alternately (in this embodiment, these terminals are arranged from left to right in the order of Ta2->Ta1->Ta2->Ta1->Ta2->Ta1). The lower terminals include a plurality of first lower terminals Tb1, a plurality of e second lower terminals Tb2, and a plurality of third lower terminals Tb3.

The power adjustment module 14 includes a power adjustment circuit. In this embodiment, the power adjustment circuit includes a first resistor R1, a second resistor R2, and a third resistor R3. The resistance values of the first resistor R1, the second resistor R2, and the third resistor R3 are not equal. The lower terminals (first lower terminal Tb1, second lower terminal Tb2, and third lower terminal Tb3) are connected to the current detection terminal CP via the power adjustment module 14. In this embodiment, the first lower terminals Tb1 are connected to the ground terminal GND and connected to the current detection terminal CP via the first resistor R1. The second lower terminals Tb2 are connected to the current detection terminal CP via the second resistor R2. The third lower terminals Tb3 are connected to the current detection terminal CP via the third resistor R3. The first lower terminals Tb1 are adjacent to each other, the second lower terminals Tb2 are adjacent to each other, and the third lower terminals Tb3 are adjacent to each other (in this embodiment, these terminals are arranged from left to right in the order of Tb3->Tb3->Tb2->Tb2->Tb1->Tb1).

The above circuit design can achieve a total of 6 level combinations, including 3 power levels and 2 color temperature levels. For example, the power level corresponding to the first resistor R1 is 24W; the power level corresponding to the second resistor R2 is 34W; the power level corresponding to the third resistor R3 is 40W (therefore, the resistance values of the first resistor R1, the second resistor R2, and the third resistor R3 are not equal; the resistance value of the first resistor R1 is greater than that of the second resistor R2; the resistance value of the second resistor R2 is greater than that of the third resistor R3); the color temperature level corresponding to the first color temperature is 5000K; the color temperature level corresponding to the second color temperature is 4000K.

When the user moves the sliding switch 14 to make the upper sliding terminal Sa and the lower sliding terminal Sb contact the first upper terminal Ta1 and the first lower terminal Tb1 respectively, the current output from the positive terminal L+ will flow through the first light-emitting module 12, the first upper terminal Ta1, and the upper sliding terminal Sa, and then return to the negative terminal L-. The current output from the current detection point CP will flow through the first resistor R1 and return to the ground terminal GND (the current output from the current detection point CP may also flow through the first resistor R1, the first lower terminal Tb1, the lower sliding terminal Sb, and then return to the ground terminal GND). At this time, the color temperature level is 5000K, and the power level is 24W.

When the user moves the sliding switch 14 to make the upper sliding terminal Sa and the lower sliding terminal Sb contact the second upper terminal Ta2 and the first lower terminal Tb1 respectively, the current output from the positive terminal L+ will flow through the second light-emitting module 13, the second upper terminal Ta2, and the upper sliding terminal Sa, and then return to the negative terminal L-. The current output from the current detection point CP will flow through the first resistor R1 and return to the ground terminal GND (the current output from the current detection point CP may also flow through the first resistor R1, the first lower terminal Tb1, the lower sliding terminal Sb, and then return to the ground terminal GND). At this time, the color temperature level is 4000K, and the power level is 24W.

When the user moves the sliding switch 14 to make the upper sliding terminal Sa and the lower sliding terminal Sb contact the first upper terminal Ta1 and the second lower terminal Tb2 respectively, the current output from the positive terminal L+ will flow through the first light-emitting module 12, the first upper terminal Ta1, and the upper sliding terminal Sa, and then return to the negative terminal L-. A portion of the current output from the current detection point CP will flow through the second resistor R1 and the lower sliding terminal Sb, and then return to the ground terminal GND. The other portion of the current output from the current detection point CP will flow through the first resistor R1 and return to the ground terminal GND. At this time, the color temperature level is 5000K, and the power level is 34W.

When the user moves the sliding switch 14 to make the upper sliding terminal Sa and the lower sliding terminal Sb contact the second upper terminal Ta2 and the second lower terminal Tb2 respectively, the current output from the positive terminal L+ will flow through the second light-emitting module 13, the second upper terminal Ta2, and the upper sliding terminal Sa, and then return to the negative terminal L-. A portion of the current output from the current detection point CP will flow through the second resistor R1 and the lower sliding terminal Sb, and then return to the ground terminal GND. The other portion of the current output from the current detection point CP will flow through the first resistor R1 and return to the ground terminal GND. At this time, the color temperature level is 4000K, and the power level is 34W.

When the user moves the sliding switch 14 to make the upper sliding terminal Sa and the lower sliding terminal Sb contact the first upper terminal Ta1 and the third lower terminal Tb3 respectively, the current output from the positive terminal L+ will flow through the first light-emitting module 12, the first upper terminal Ta1, and the upper sliding terminal Sa, and then return to the negative terminal L-. A portion of the current output from the current detection point CP will flow through the third resistor R3 and the lower sliding terminal Sb, and then return to the ground terminal GND. The other portion of the current output from the current detection point CP will flow through the first resistor R1 and return to the ground terminal GND. At this time, the color temperature level is 5000K, and the power level is 40W.

When the user moves the sliding switch 14 to make the upper sliding terminal Sa and the lower sliding terminal Sb contact the second upper terminal Ta2 and the third lower terminal Tb3 respectively, the current output from the positive terminal L+ will flow through the second light-emitting module 13, the second upper terminal Ta2, and the upper sliding terminal Sa, and then return to the negative terminal L-. A portion of the current output from the current detection point CP will flow through the third resistor R3 and the lower sliding terminal Sb, and then return to the ground terminal GND. The other portion of the current output from the current detection point CP will flow through the first resistor R1 and return to the ground terminal GND. At this time, the color temperature level is 4000K, and the power level is 40W.

Through the above circuit design, the first resistor R1 can serve as an auxiliary current path for other power levels, reducing the number of resistors used in the power adjustment module 14.

Through the above circuit design, the lighting adjustment circuit 1 can simultaneously provide color temperature adjustment and power adjustment functions, allowing users to conveniently perform both color temperature adjustment and power adjustment for lighting devices. Therefore, the lighting adjustment circuit 1 can meet practical application requirements.

Through the above simple and optimized circuit design, the lighting adjustment circuit 1 achieves color temperature adjustment and power adjustment functions and is easy to operate. Therefore, the lighting adjustment circuit can meet actual requirements.

Additionally, in this embodiment, the lighting adjustment circuit 1 can simultaneously provide color temperature adjustment and power adjustment functions and can provide an intuitive operation interface. Thus, the user can more simply and efficiently perform both color temperature adjustment and power adjustment for lighting devices. Therefore, the lighting adjustment circuit 1 is not only more convenient to use but can also enhance the user experience.

Furthermore, in this embodiment, the lower terminals include a plurality of first lower terminals Tb1, a plurality of second lower terminals Tb2, and a plurality of third lower terminals Tb3. The power adjustment module 14 includes a first resistor R1, a second resistor R2, and a third resistor R3. The first lower terminals Tb1 are connected to the ground terminal GND and connected to the current detection terminal CP via the first resistor R1. The multiple second lower terminals Tb2 are connected to the current detection terminal CP via the second resistor R2. The third lower terminals Tb3 are connected to the current detection terminal CP via the third resistor R3. The above circuit design can effectively reduce the number of resistors in the power adjustment module 14, greatly simplifying the circuit of the lighting adjustment circuit 1. Therefore, the cost of the lighting adjustment circuit 1 can be significantly reduced to meet the requirements of different applications.

Moreover, in this embodiment, the circuit design of the lighting adjustment circuit 1 allows the number of color temperature levels and power levels to be increased or decreased according to actual requirements. Thus, the lighting adjustment circuit 1 can not only meet the requirements of different lighting devices but can also satisfy more diverse application requirements. Therefore, the lighting adjustment circuit 1 is more flexible in use and can be more comprehensive in application.

The embodiment just exemplifies the disclosure and is not intended to limit the scope of the disclosure; any equivalent modification and variation according to the spirit of the disclosure is to be also included within the scope of the following claims and their equivalents.

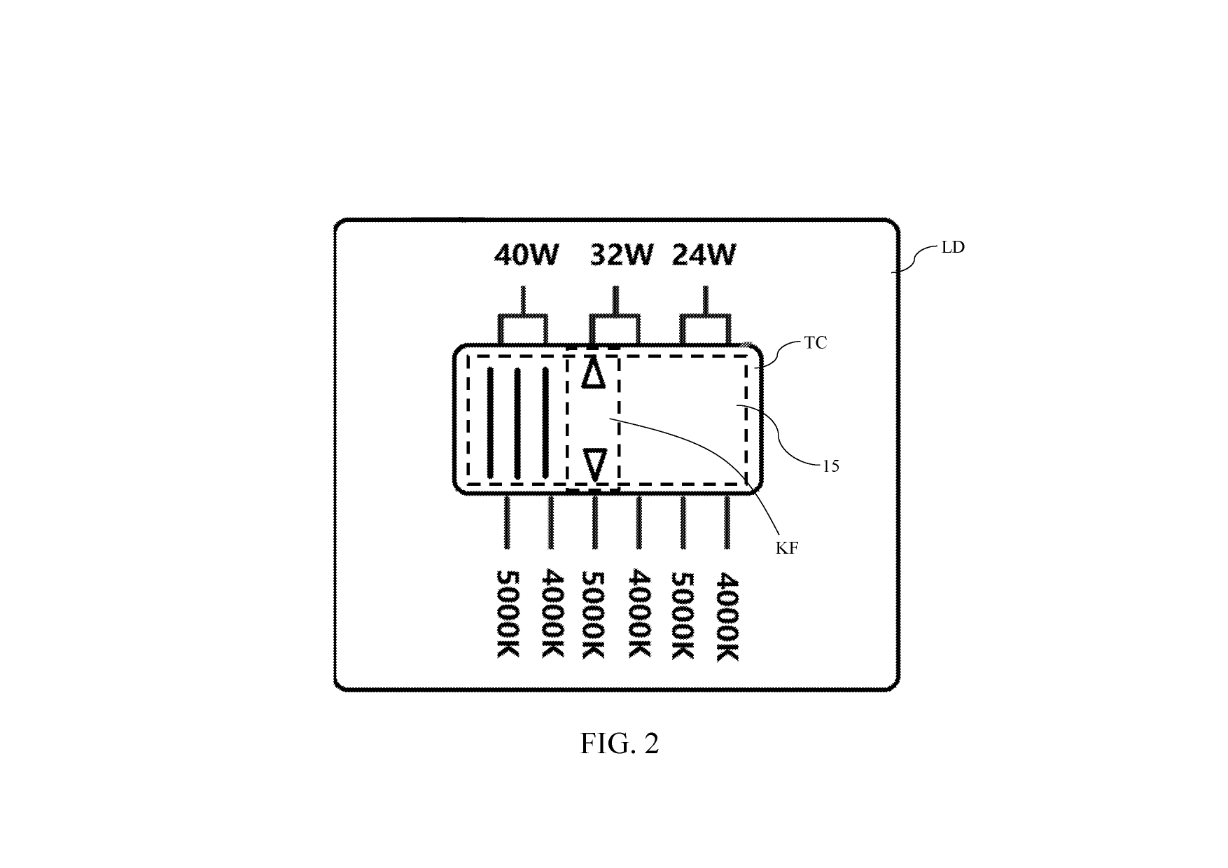

Please refer to FIG. 2, which is a schematic view for illustrating a sliding switch of the multi-functional lighting adjustment circuit on a lighting device in accordance with the first embodiment of the disclosure. As shown in FIG. 2, the sliding switch 15 may be disposed on any surface portion of the lighting device. For example, the sliding switch 15 may be disposed on the end cap of a tube light LD. The sliding switch 15 further includes an outer cover TC. The outer cover TC may be fixed to the handle Hd, allowing users to move the handle Hd by moving the outer cover TC. The outer cover TC may be marked with indicator symbols KF (such as arrows), while the corresponding surface of the tube light LD may be marked with associated power levels and color temperature levels. This configuration enables the user to quickly and intuitively identify the current power level and color temperature level settings. In another embodiment, the lighting device may also be a downlight, a panel light, or other currently available lighting devices.

The embodiment just exemplifies the disclosure and is not intended to limit the scope of the disclosure; any equivalent modification and variation according to the spirit of the disclosure is to be also included within the scope of the following claims and their equivalents.

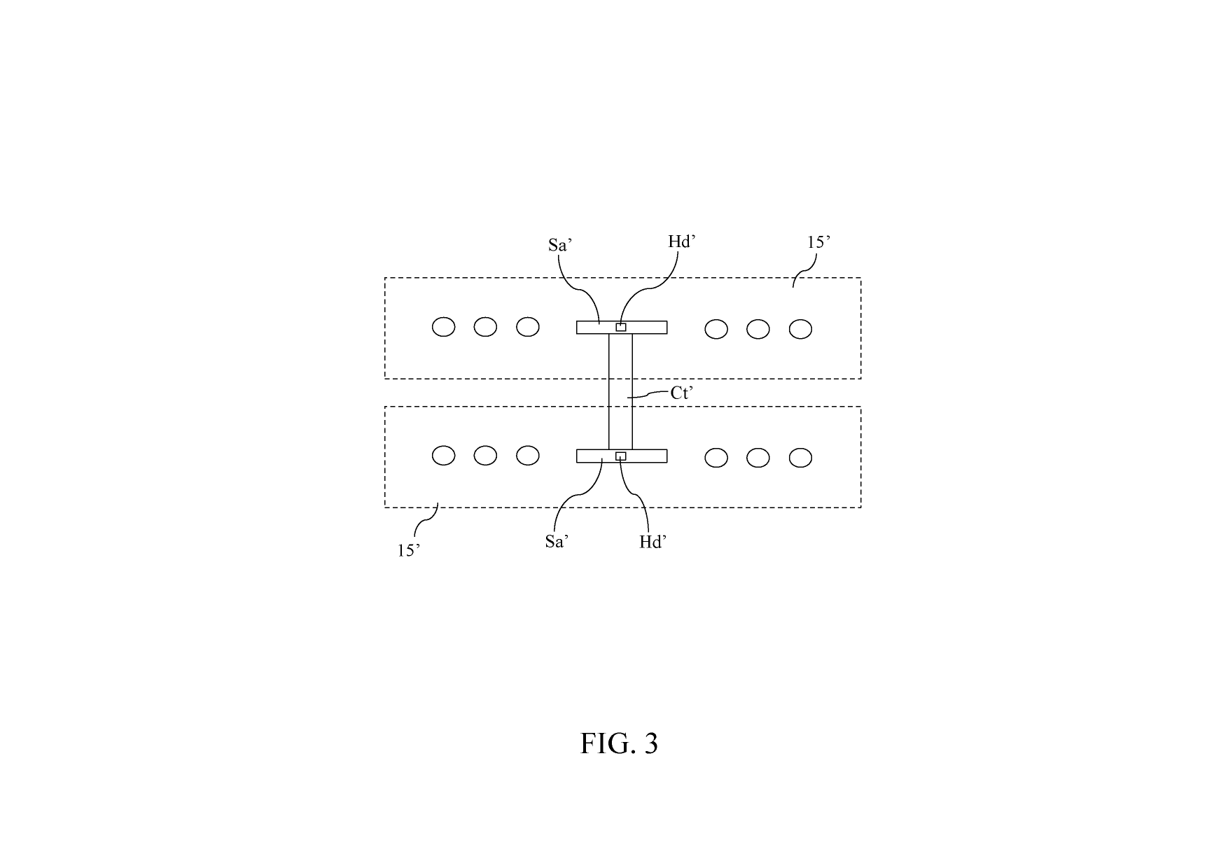

Please refer to FIG. 3, which is a schematic view of a structure of a sliding switch in accordance with a second embodiment of the disclosure. As shown in FIG. 3, the sliding switch 15 of the first embodiment can be implemented as a dual-row linkage mechanism by connecting two currently available sliding switches 15'. The sliding terminals Sa' of the two sliding switches 15' may be interconnected via a connection part Ct'.

Thus, the user may simultaneously operate both sliding switches 15' by moving the handle Hd' of either sliding switch 15', thereby achieving synchronized movement of both sliding switches 15'.

The embodiment just exemplifies the disclosure and is not intended to limit the scope of the disclosure; any equivalent modification and variation according to the spirit of the disclosure is to be also included within the scope of the following claims and their equivalents.

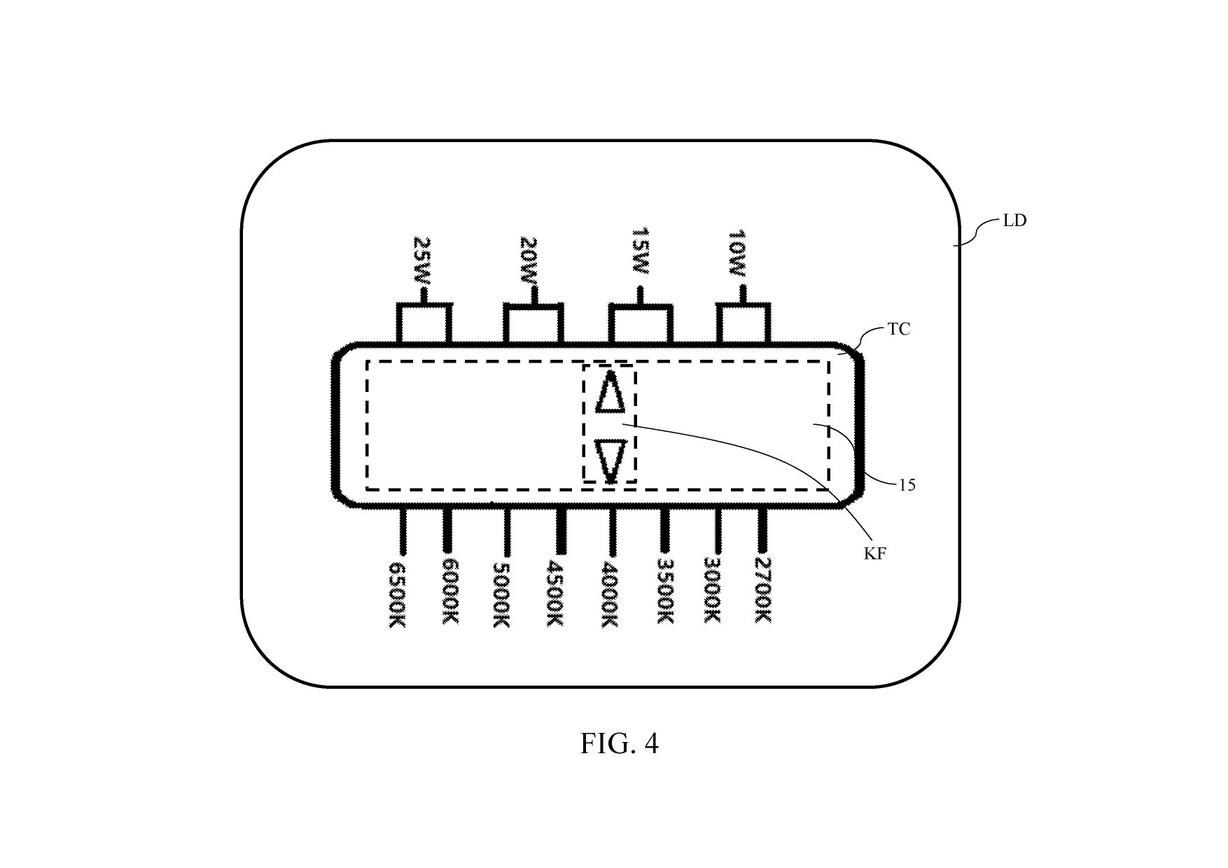

Please refer to FIG. 4, which is a schematic view for illustrating a sliding switch of a multi-functional lighting adjustment circuit on a lighting device in accordance with a third embodiment of the disclosure. As shown in FIG. 4, different from the previous embodiments, the lighting adjustment circuit 1 has 8 color temperature levels and 4 power levels.

The 8 color temperature levels include: 2700K, 3000K, 3500K, 4000K, 4500K, 5000K, 6000K, and 6500K. The 4 power levels include: 10W, 15W, 20W, and 25W. Through the above circuit design, both the color temperature levels and power levels of the lighting adjustment circuit 1 can be increased or decreased according to actual requirements.

As demonstrated above, the lighting adjustment circuit 1 can simultaneously provide both color temperature adjustment and power adjustment functions, while offering an intuitive operation interface. This enables the user to perform both color temperature adjustment and power adjustment for lighting devices more simply and efficiently. Consequently, the lighting adjustment circuit 1 is not only more convenient to use but also enhances user experience.

Furthermore, as set forth above, the circuit design of the lighting adjustment circuit 1 allows the number of both color temperature levels and power levels to be increased or decreased according to actual requirements. Therefore, the lighting adjustment circuit 1 can not only meet the requirements of different lighting devices but also satisfy more diverse application needs. Thus, the lighting adjustment circuit 1 can be more flexible in use and more comprehensive in application.

The embodiment just exemplifies the disclosure and is not intended to limit the scope of the disclosure; any equivalent modification and variation according to the spirit of the disclosure is to be also included within the scope of the following claims and their equivalents.

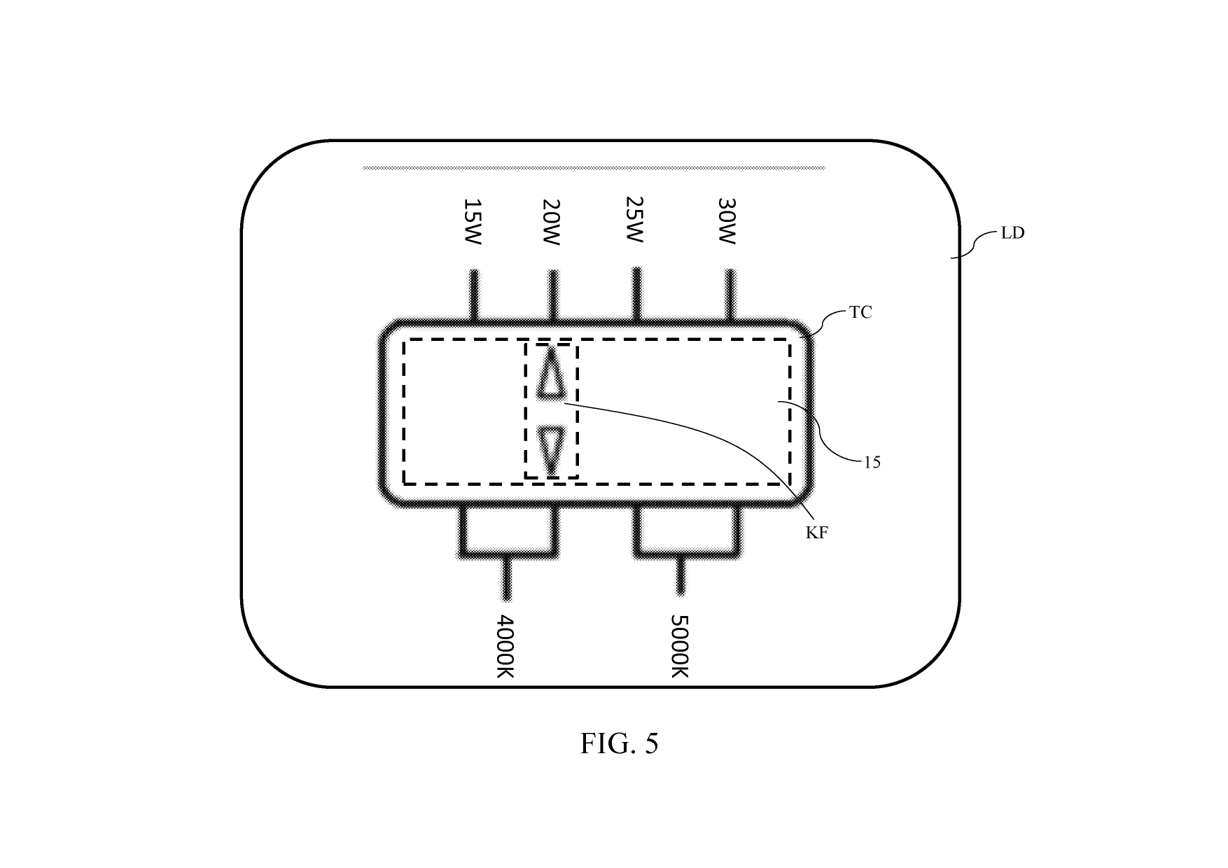

Please refer to FIG. 5 is a schematic view for illustrating a sliding switch of a multi-functional lighting adjustment circuit on a lighting device in accordance with the fourth embodiment of the disclosure. As shown in FIG. 5, different from the previous embodiments, the lighting adjustment circuit 1 has 2 color temperature levels and 4 power levels. The 2 color temperature levels include: 4000K and 5000K. The 4 power levels include: 15W, 20W, 25W, and 30W. Through the above circuit design, both the color temperature levels and power levels of the lighting adjustment circuit 1 can be increased or decreased according to actual requirements.

As demonstrated above, the lighting adjustment circuit 1 can simultaneously provide both color temperature adjustment and power adjustment functions, while offering an intuitive operation interface. This enables users to perform both color temperature adjustment and power adjustment for lighting devices more simply and efficiently. Consequently, the lighting adjustment circuit 1 is not only more convenient to use but also enhances user experience.

Furthermore, as shown above, the circuit design of the lighting adjustment circuit 1 allows the number of both color temperature levels and power levels to be increased or decreased according to actual requirements. Therefore, the lighting adjustment circuit 1 can not only meet the requirements of different lighting devices but also satisfy more diverse application needs. Thus, the lighting adjustment circuit 1 can be more flexible in use and more comprehensive in application.

The embodiment just exemplifies the disclosure and is not intended to limit the scope of the disclosure; any equivalent modification and variation according to the spirit of the disclosure is to be also included within the scope of the following claims and their equivalents.

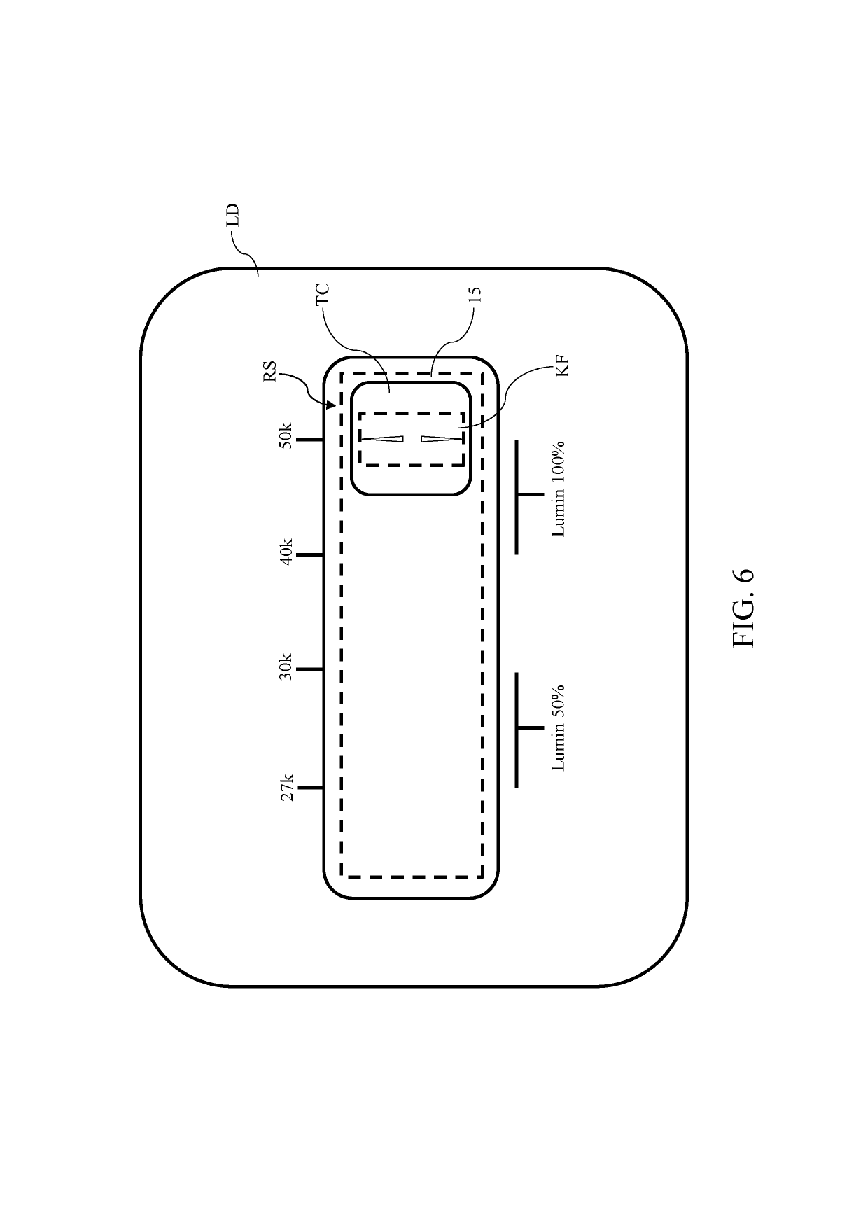

Please refer to FIG. 6, which is a schematic view for illustrating a sliding switch of a multi-functional lighting adjustment circuit on a lighting device in accordance with the fifth embodiment of the disclosure. As shown in FIG. 6, the difference between this embodiment and the previous embodiment is that the lighting adjustment circuit 1 includes four color temperature levels and two power levels. The four color temperature levels include 50K, 40K, 30K, and 27K. The two lumination levels include 100% and 50%. In addition, the surface of the lighting device LD is provided with a recess RS, and the outer cover TC of the sliding switch 15 is disposed within the recess RS.

The embodiment just exemplifies the disclosure and is not intended to limit the scope of the disclosure; any equivalent modification and variation according to the spirit of the disclosure is to be also included within the scope of the following claims and their equivalents.

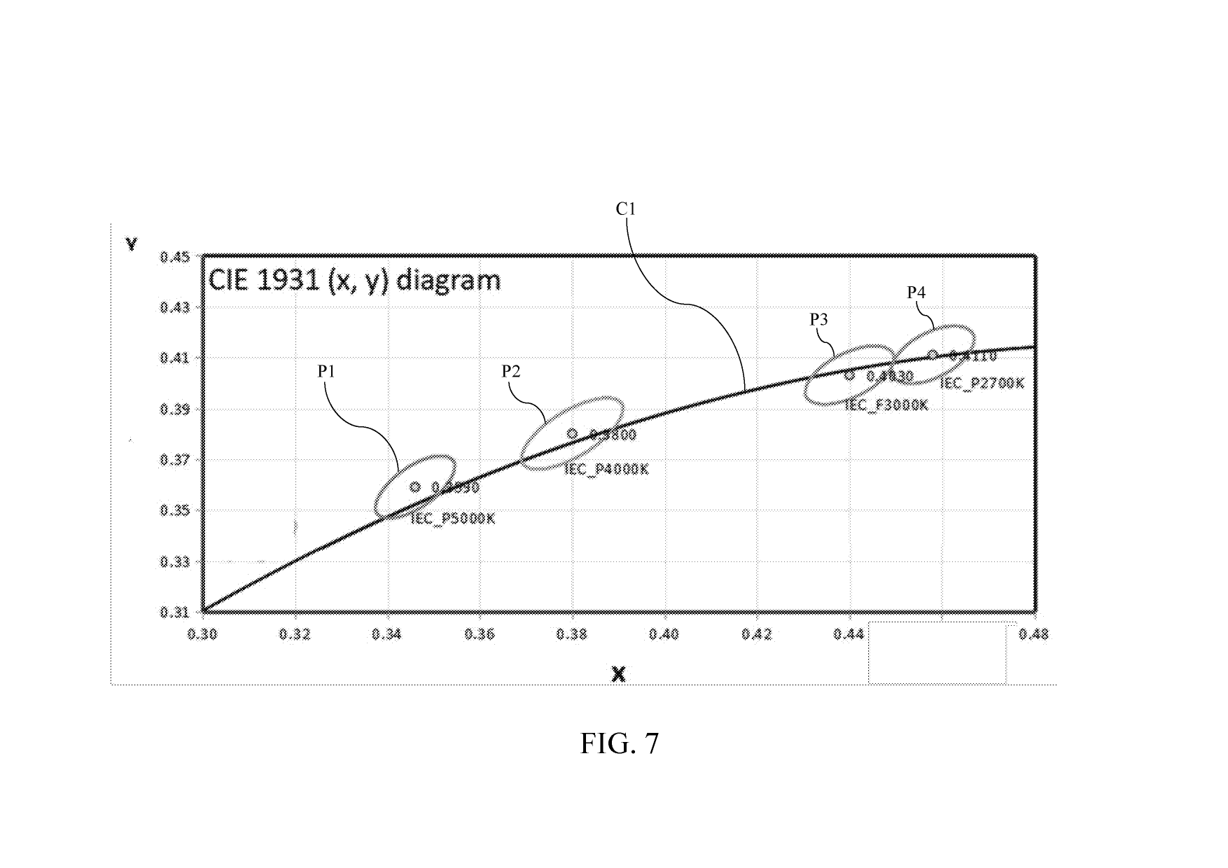

Please refer to FIG. 7, which is a mixed-light diagram of the multi-functional lighting adjustment circuit of the fifth embodiment of the disclosure. FIG. 7 exemplarily illustrates the mixed-light effect of the lighting adjustment circuit 1 of this embodiment. As shown in FIG. 7, C1 stands for the Planckian locus, while P1, P2, P3, and P4 stand for examples of the four color temperature points.

From the above, it can be understood that the lighting adjustment circuit 1 can indeed achieve color temperature adjustment and power adjustment functions to realize the desired technical effects through the simple and optimized circuit design described above.

The embodiment just exemplifies the disclosure and is not intended to limit the scope of the disclosure; any equivalent modification and variation according to the spirit of the disclosure is to be also included within the scope of the following claims and their equivalents.

As previously stated, according to one embodiment of the disclosure, the multi-functional lighting adjustment circuit includes a plurality of light-emitting modules, a constant-current driving module and a sliding switch. The constant-current driving module is connected to the light-emitting modules. The sliding switch is connected to the constant-current driving module, and has a plurality of color temperature levels and a plurality of power levels. The sliding switch is moved to simultaneously trigger one of the color temperature levels and one of the power levels. The constant-current driving module drives one or more of the light-emitting modules according to the color temperature level and the power level triggered by the sliding switch. Through the above circuit design, the lighting adjustment circuit can simultaneously provide color temperature adjustment and power adjustment functions, so the user can conveniently perform both color temperature adjustment and power adjustment for lighting devices. Therefore, the lighting adjustment circuit can meet actual requirements.

According to one embodiment of the disclosure, the lighting adjustment circuit further includes a power adjustment module. The constant-current driving module has a positive terminal, a negative terminal, a current detection terminal, and a ground terminal. The light-emitting modules include a first light-emitting module and a second light-emitting module. The first light-emitting module is connected to the positive terminal and has a first color temperature. The second light-emitting module is connected to the positive terminal and has a second color temperature different from the first color temperature. The sliding switch has a plurality of upper terminals, a plurality of lower terminals, an upper sliding terminal, and a lower sliding terminal. A portion of the upper terminals is connected to the first light-emitting module, while the other portion of the upper terminals is connected to the second light-emitting module. The lower terminals are connected to the current detection terminal through the power adjustment module, while a portion of the lower terminals is connected to the ground terminal. The upper sliding terminal is connected to the negative terminal, and the lower sliding terminal is connected to the ground terminal. The upper sliding terminal can move to the position of any one of the upper terminals to contact this upper terminal, while the lower sliding terminal can move to the position of any one of the lower terminals to contact this lower terminal. The lighting adjustment circuit can achieve both color temperature adjustment and power adjustment functions via the above simple and optimized circuit design and is easy to operate. Therefore, the lighting adjustment circuit can meet actual requirements.

According to one embodiment of the disclosure, the lighting adjustment circuit can simultaneously provide color temperature adjustment and power adjustment functions, and can provide an intuitive operation interface. Thus, users can more simply and efficiently perform both color temperature adjustment and power adjustment for lighting devices. Therefore, the lighting adjustment circuit is not only more convenient to use but can also enhance user experience.

Also, according to one embodiment of the disclosure, the lower terminals include a plurality of first lower terminals, a plurality of second lower terminals, and a plurality of third lower terminals. The power adjustment module includes a first resistor, a second resistor, and a third resistor. The first lower terminals are connected to the ground terminal and further connected to the current detection terminal via the first resistor. The second lower terminals are connected to the current detection terminal via the second resistor. The third lower terminals are connected to the current detection terminal via the third resistor. The above circuit design can effectively reduce the number of resistors in the power adjustment module, significantly simplifying the circuit of the lighting adjustment circuit. Therefore, the cost of the lighting adjustment circuit can be greatly reduced to meet different application requirements.

Further, according to one embodiment of the disclosure, the circuit design of the lighting adjustment circuit allows the number of color temperature levels and power levels to be increased or decreased according to actual needs. Thus, the lighting adjustment circuit can not only meet the requirements of different lighting devices but can also satisfy more diverse application needs. Therefore, the lighting adjustment circuit can be more flexible in use and more comprehensive in application.

Moreover, according to one embodiment of the disclosure, the circuit design of the lighting adjustment circuit can adopt either an isolated driver or a non-isolated driver, further improving the reliability of the lighting adjustment circuit. Therefore, the lighting adjustment circuit can meet the requirements of applications demanding high reliability.

Furthermore, according to one embodiment of the disclosure, the circuit design of the lighting adjustment circuit is simple, so the lighting adjustment circuit can achieve the desired effects while reducing costs. Therefore, the practicality of the lighting adjustment circuit can be significantly enhanced in order to align with future development trends.

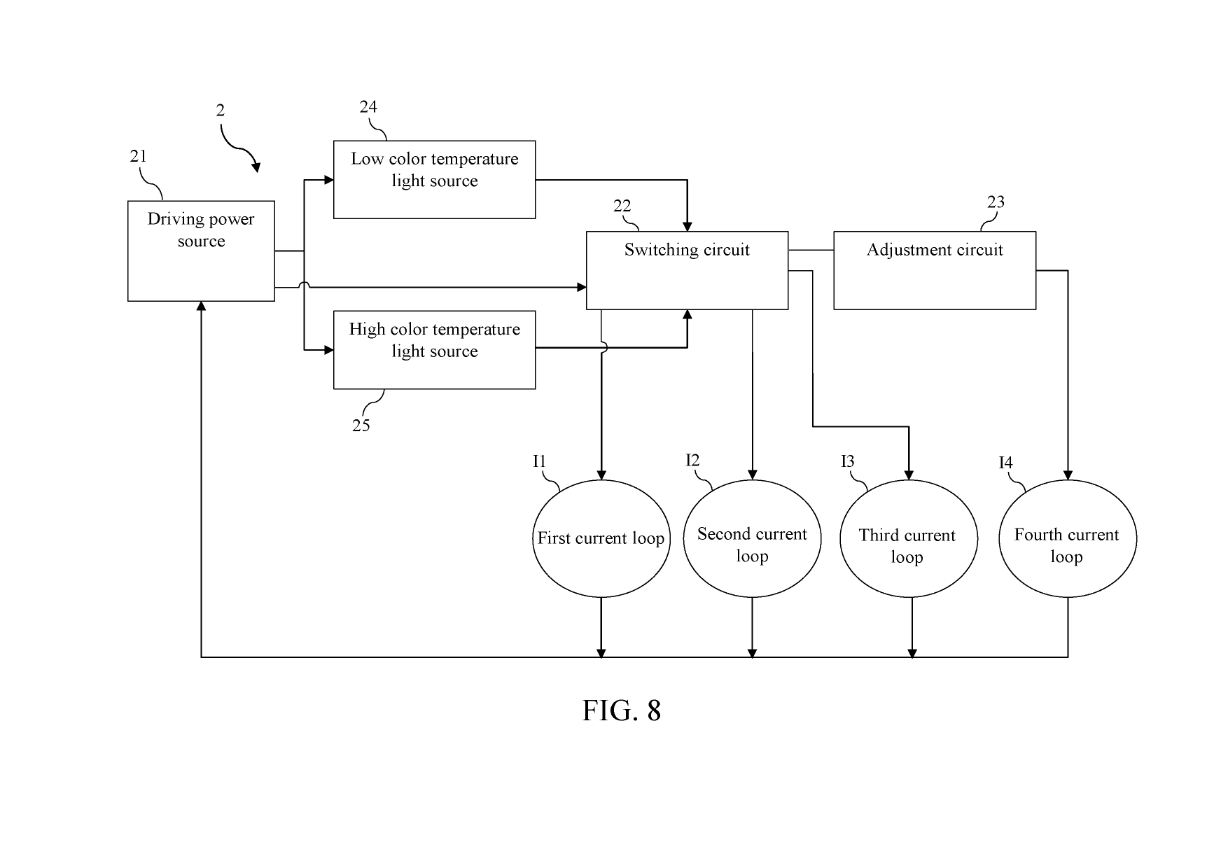

Please refer to FIG. 8, which is a schematic view of a circuit structure of a lighting adjustment circuit having color temperature adjustment function in accordance with a sixth embodiment of the disclosure. As shown in FIG. 8, the lighting adjustment circuit 2 includes a driving power source 21, a switching circuit 22, an adjustment circuit 23, a low color temperature light source 24, and a high color temperature light source 25.

The driving power source 21 is connected to the switching circuit 22. In one embodiment, the driving power source 21 may be any of various currently available LED drivers.

The low color temperature light source 24 is connected to the driving power source 21 and the switching circuit 22. In one embodiment, the color temperature of the low color temperature light source 24 may be 3000K, and the low color temperature light source 24 may include one or more LEDs, which may be connected in series or in parallel. In another embodiment, the color temperature of the low color temperature light source 24 may be 2500K. In yet another embodiment, the color temperature of the low color temperature light source 24 may be 2000K. The above examples are provided for illustration purposes only, and the color temperature of the low color temperature light source 24 may be determined according to actual requirements.

The high color temperature light source 25 is connected to the driving power source 21 and the switching circuit 22. The color temperature of the high color temperature light source 25 is greater than the color temperature of the low color temperature light source 24. The color temperature of the high color temperature light source 25 is from two times to three times the color temperature of the low color temperature light source 24. In one embodiment, the color temperature of the high color temperature light source 25 may be 6500K, and the high color temperature light source 25 may include one or more LEDs, which may be connected in series or in parallel. In another embodiment, the color temperature of the high color temperature light source 25 may be 6000K. In yet another embodiment, the color temperature of the high color temperature light source 25 may be 7000K. The above examples are provided for illustration purposes only, and the color temperature of the high color temperature light source 25 may be determined according to actual requirements.

The adjustment circuit 23 is connected to the switching circuit 22. In one embodiment, the adjustment circuit 23 may be a shunt resistor. In another embodiment, the adjustment circuit 23 may be a circuit including a plurality of resistors, which may be connected in series or in parallel. In yet another embodiment, the adjustment circuit 23 may include both a series circuit and a parallel circuit.

In this embodiment, the switching circuit 22 is switched to make the driving power source 21 form at least three current loops to drive the low color temperature light source 24 and the high color temperature light source 25. The user may operate the switching circuit 22 to enter an intermediate color temperature mode, a high color temperature mode, or a low color temperature mode. The high color temperature mode indicates that the color temperature of the lighting adjustment circuit 2 is 6500K. The low color temperature mode indicates that the color temperature of the lighting adjustment circuit 2 is 3000K. The color temperature of the intermediate color temperature mode is lower than the color temperature of the high color temperature light source 25 and higher than the color temperature of the low color temperature light source 24. That is, the intermediate color temperature mode indicates that the color temperature of the lighting adjustment circuit 2 is greater than 3000K and less than 6500K, such as 3500K, 4000K, or 5000K. The color temperature of the high color temperature mode is substantially equal to or close to the color temperature of the high color temperature light source 25. The color temperature of the low color temperature mode is substantially equal to or close to the color temperature of the low color temperature light source 24.

When the user operates the switching circuit 22 to enter the intermediate color temperature mode, the switching circuit 22 is switched to make the driving power source 21 form a first current loop I1 passing through the switching circuit 22, a second current loop I2 passing through the high color temperature light source 25 and the switching circuit 22, and a third current loop I3 passing through the low color temperature light source 24 and the switching circuit 22. The sum of the currents of the first current loop I1, the second current loop I2, and the third current loop I3 is the total output current of the driving power source 21, and the total output current flows back to the driving power source 21.

In the intermediate color temperature mode, the current of the second current loop I2 is substantially equal to the current of the third current loop I3 (“substantially equal to” means that the current of the second current loop I2 is equal to, close to or very close to the current of the third current loop I3). For example, the difference between the current of the second current loop I2 and the current of the third current loop I3 is greater than or equal to 1 percent of the total current but less than 20 percent of the total current. The current of the second current loop I2 and the current of the third current loop I3 are substantially greater than the current of the first current loop I1. For example, the current of the second current loop I2 is ten times or more than the current of the first current loop I1, and the current of the third current loop I3 is also ten times or more than the current of the first current loop I1. For example, the current of the first current loop I1 is 1 percent of the total current, the current of the second current loop I2 is 49 percent of the total current, and the current of the third current loop I3 is 50 percent of the total current. For another example, the current of the first current loop I1 is 2 percent of the total current, the current of the second current loop I2 is 45 percent of the total current, and the current of the third current loop I3 is 53 percent of the total current. The current of the first current loop I1 accounts for a minor portion of the total current, while the currents of the second current loop I2 and the third current loop I3 together account for a major portion of the total current. The currents of the first current loop I1, the second current loop I2, and the third current loop I3 may be adjusted to achieve a desired color temperature.

When the user operates the switching circuit 22 to enter the high color temperature mode, the switching circuit 22 is switched to make the driving power source 21 form a first current loop I1 passing through the switching circuit 22, a second current loop I2 passing through the high color temperature light source 25 and the switching circuit 22, and a fourth current loop I4 passing through the low color temperature light source 24, the switching circuit 22, and the adjustment circuit 23. The sum of the currents of the first current loop I1, the second current loop I2, and the fourth current loop I4 is the total output current of the driving power source 21, and the total output current flows back to the driving power source 21.

In the high color temperature mode, the current of the second current loop I2 is substantially greater than the current of the first current loop I1 and the current of the fourth current loop I4. For example, the difference between the current of the second current loop I2 and the current of the first current loop I1 is greater than or equal to 97 percent of the total current but less than 100 percent of the total current. For example, the difference between the current of the second current loop I2 and the current of the fourth current loop I4 is greater than or equal to 97 percent of the total current but less than 100 percent of the total current. The current of the first current loop I1 is substantially equal to the current of the fourth current loop I4 (“substantially equal to” means that the current of the first current loop I1 is equal to, close to or very close to the current of the fourth current loop I4). For example, the current of the first current loop I1 and the current of the fourth current loop I4 are each equal to 1 percent of the total current. For another example, the difference between the current of the first current loop I1 and the current of the fourth current loop I4 is less than 2 percent of the total current. For example, the current of the second current loop I2 is 98 percent of the total current, the current of the first current loop I1 is 1 percent of the total current, and the current of the fourth current loop I4 is 1 percent of the total current. The currents of the first current loop I1, the second current loop I2, and the fourth current loop I4 may be adjusted to achieve a desired color temperature. The current of the second current loop I2 is significantly greater than the currents of the first current loop I1 and the fourth current loop I4, and the current of the first current loop I1 is close to the current of the fourth current loop I4. In the high color temperature mode, the fourth current loop I4 still passes through the low color temperature light source 24. Therefore, in the high color temperature mode, the driving power source 21 drives the high color temperature light source 25 with a majority of the current and drives the low color temperature light source 24 with a very small current. Accordingly, in the high color temperature mode, the lighting adjustment circuit 2 mainly outputs high color temperature light from the high color temperature light source 25, while low color temperature light generated by the low color temperature light source 24 is mixed with the high color temperature light to enhance special color rendering (R9) of the mixed light.

When the user operates the switching circuit 22 to enter the low color temperature mode, the switching circuit 22 is switched to make the driving power source 21 form a first current loop I1 passing through the switching circuit 22, a third current loop I3 passing through the low color temperature light source 24 and the switching circuit 22, and a fourth current loop I4 passing through the high color temperature light source 25, the switching circuit 22, and the adjustment circuit 23. The sum of the currents of the first current loop I1, the third current loop I3, and the fourth current loop I4 is the total output current of the driving power source 21, and the total output current flows back to the driving power source 21.

In the low color temperature mode, the current of the third current loop I3 is substantially greater than the current of the first current loop I1 and the current of the fourth current loop I4. For example, a difference between the current of the third current loop I3 and the current of the first current loop I1 is greater than or equal to 97 percent of the total current but less than 100 percent of the total current. For example, the difference between the current of the third current loop I3 and the current of the fourth current loop I4 is greater than or equal to 97 percent of the total current but less than 100 percent of the total current. The current of the first current loop I1 is substantially equal to the current of the fourth current loop I4 (“substantially equal to” means that the current of the first current loop I1 is equal to, close to or very close to the current of the fourth current loop I4). For example, the current of the first current loop I1 and the current of the fourth current loop I4 are each equal to 1 percent of the total current. For another example, the difference between the current of the first current loop I1 and the current of the fourth current loop I4 is less than 2 percent of the total current. For example, the current of the third current loop I3 is 98 percent of the total current, the current of the first current loop I1 is 1 percent of the total current, and the current of the fourth current loop I4 is 1 percent of the total current. The current of the third current loop I3 is significantly greater than the currents of the first current loop I1 and the fourth current loop I4, and the current of the first current loop I1 is close to the current of the fourth current loop I4. The currents of the first current loop I1, the third current loop I3, and the fourth current loop I4 may be adjusted to achieve a desired color temperature. In the low color temperature mode, the fourth current loop I4 still passes through the high color temperature light source 25. Therefore, in the low color temperature mode, the driving power source 21 drives the low color temperature light source 24 with a majority of the current and drives the high color temperature light source 25 with a very small current. Accordingly, in the low color temperature mode, the lighting adjustment circuit 2 mainly outputs low color temperature light from the low color temperature light source 24, while high color temperature light generated by the high color temperature light source 25 is mixed with the low color temperature light to enhance luminous efficacy of the mixed light.

Through the above-described circuit design and switching mechanism of the switching circuit, the driving power source 21 is capable of forming three current loops to drive the low color temperature light source 24 and the high color temperature light source 25, such that the lighting adjustment circuit 2 can achieve a greater number of color temperature adjustment levels to meet the requirements of different applications. In addition, the total current used to drive the low color temperature light source 24 and the high color temperature light source 25 is always less than the total output current.

In addition, in the high color temperature mode, the driving power source 21 drives the high color temperature light source 25 with a majority of the current and drives the low color temperature light source 24 with a very small current. Accordingly, in the high color temperature mode, the lighting adjustment circuit 2 mainly outputs high color temperature light from the high color temperature light source 25, while low color temperature light generated by the low color temperature light source 24 is mixed with the high color temperature light to enhance special color rendering (R9) of the mixed light. Similarly, in the low color temperature mode, the driving power source 21 drives the low color temperature light source 24 with a majority of the current and drives the high color temperature light source 25 with a very small current. Accordingly, in the low color temperature mode, the lighting adjustment circuit 2 mainly outputs low color temperature light from the low color temperature light source 24, while high color temperature light generated by the high color temperature light source 25 is mixed with the low color temperature light to enhance luminous efficacy of the mixed light.

As can be understood from the above, the circuit design and the switching mechanism of the switching circuit of the lighting adjustment circuit 2 can be applied to various currently available LED lighting devices and can effectively achieve a greater number of color temperature adjustment levels. At the same time, the circuit design and the switching mechanism of the switching circuit can enhance luminous efficacy and special color rendering (R9) of the lighting adjustment circuit 2. Therefore, the lighting adjustment circuit 2 can be more comprehensive in application and more flexible in use.

The embodiment just exemplifies the disclosure and is not intended to limit the scope of the disclosure; any equivalent modification and variation according to the spirit of the disclosure is to be also included within the scope of the following claims and their equivalents.

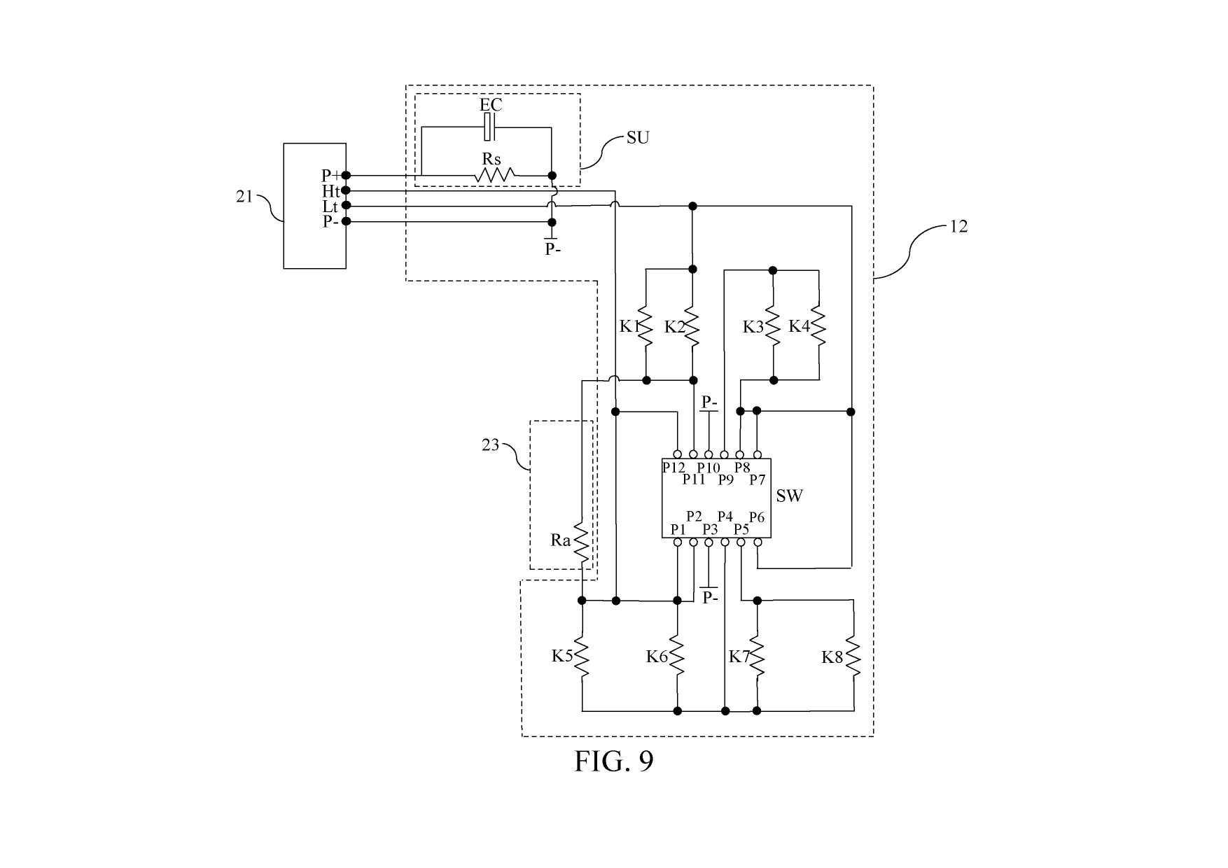

Please refer to FIG. 9, which is a circuit diagram of a switching circuit of a lighting adjustment circuit having color temperature adjustment function in accordance with a seventh embodiment of the disclosure (including a portion of the driving circuit 21 and the adjustment circuit 23). Please also refer to FIG. 8. As shown in FIG. 9, the switching circuit 22 includes a stabilization unit SU, a switch SW (the switch SW has twelve pins P1 to P12), a first resistor unit K1, a second resistor unit K2, a third resistor unit K3, a fourth resistor unit K4, a fifth resistor unit K5, a sixth resistor unit K6, a seventh resistor unit K7, and an eighth resistor unit K8. Each of the first resistor unit K1, the second resistor unit K2, the third resistor unit K3, the fourth resistor unit K4, the fifth resistor unit K5, the sixth resistor unit K6, the seventh resistor unit K7, and the eighth resistor unit K8 may be a resistor. The stabilization unit SU includes a current-consuming resistor Rs and a filtering capacitor EC connected in parallel with each other. In one embodiment, the switch SW may be a dual-row toggle switch, a single-row toggle switch, a photo relay, a metal-oxide-semiconductor field-effect transistor (MOS), a thyristor, or other semiconductor switching components. In another embodiment, each of the first resistor unit K1, the second resistor unit K2, the third resistor unit K3, the fourth resistor unit K4, the fifth resistor unit K5, the sixth resistor unit K6, the seventh resistor unit K7, and the eighth resistor unit K8 may be a series circuit or a parallel circuit including a plurality of resistors.

The adjustment circuit 23 includes a shunt resistor Ra. The adjustment circuit 23 is connected to the switching circuit 22, and the low color temperature light source 24 and the high color temperature light source 25 are illustrated in FIG. 8.

The driving circuit 21 includes a positive live wire output terminal P+, a negative live wire output terminal P-, a high color temperature output terminal Ht, and a low color temperature output terminal Lt. The positive live wire output terminal P+ is connected to the negative live wire output terminal P- through the stabilization unit SU. The high color temperature output terminal Ht and the low color temperature output terminal Lt are both connected to the switch SW. In addition, the first resistor unit K1, the second resistor unit K2, the third resistor unit K3, the fourth resistor unit K4, the fifth resistor unit K5, the sixth resistor unit K6, the seventh resistor unit K7, and the eighth resistor unit K8 are disposed between the high color temperature output terminal Ht and the low color temperature output terminal Lt and the switch SW. The first resistor unit K1 and the second resistor unit K2 are connected in parallel. The third resistor unit K3 and the fourth resistor unit K4 are connected in parallel. The fifth resistor unit K5 and the sixth resistor unit K6 are connected in parallel. The seventh resistor unit K7 and the eighth resistor unit K8 are connected in parallel. The high color temperature output terminal Ht outputs current to the high color temperature light source 25, and the low color temperature output terminal Lt outputs current to the low color temperature light source 24.

The embodiment just exemplifies the disclosure and is not intended to limit the scope of the disclosure; any equivalent modification and variation according to the spirit of the disclosure is to be also included within the scope of the following claims and their equivalents.

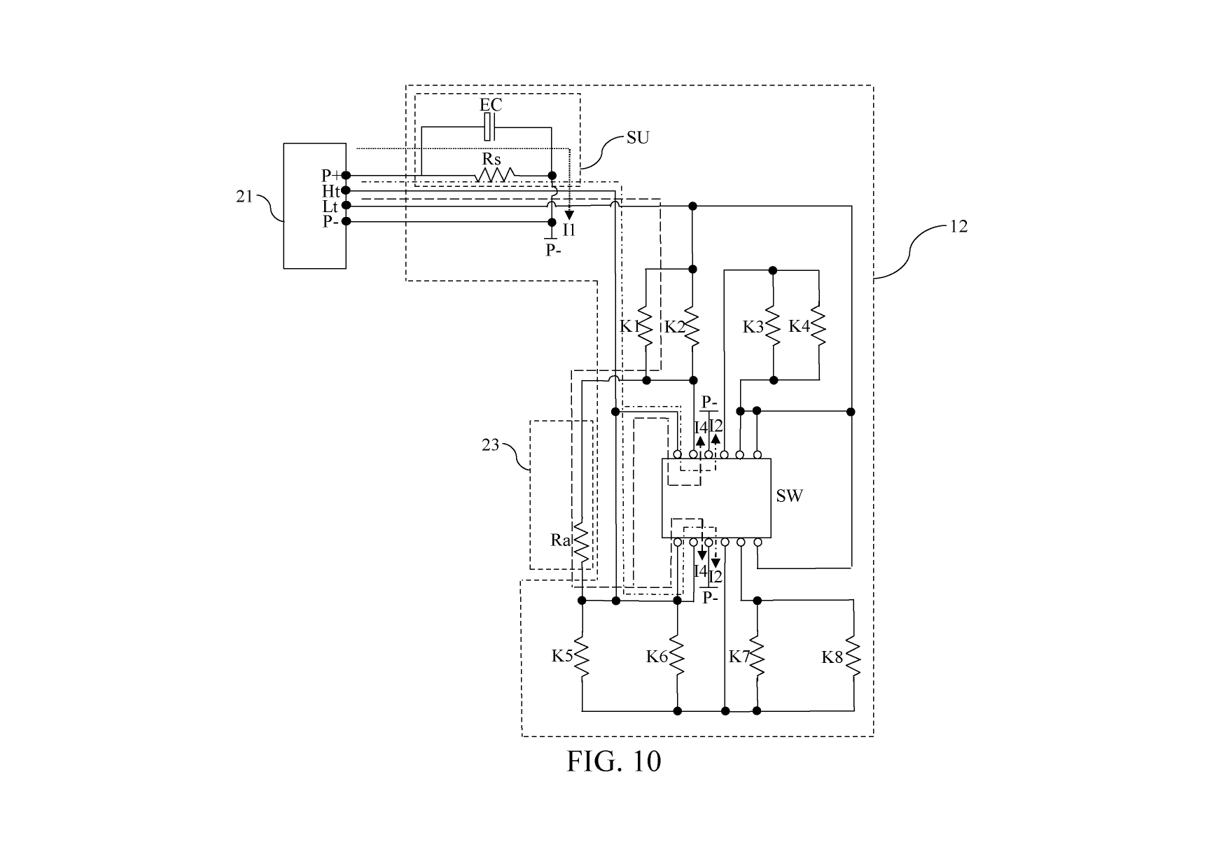

Please refer to FIG. 10, which is a schematic view of a high color temperature mode of the switching circuit of the lighting adjustment circuit having color temperature adjustment function in accordance with the seventh embodiment of the disclosure. Please also refer to FIG. 6 and FIG. 7. As shown in FIG. 10, when the user operates the switching circuit 22 to enter the high color temperature mode, the switching circuit 22 is switched to make the driving power source 21 form a first current loop I1 passing through the switching circuit 22, a second current loop I2 passing through the high color temperature light source 25 and the switching circuit 22, and a fourth current loop I4 passing through the low color temperature light source 24, the switching circuit 22, and the adjustment circuit 23.

The first current loop I1 is output from the positive live wire output terminal P+ of the driving power source 21 and returns to the negative live wire output terminal P- of the driving power source 21 through the stabilization unit SU (the current-consuming resistor Rs), and the filtering capacitor EC provides the filtering effect. The current of the first current loop I1 accounts for 1 percent of the total current. In addition, when the lighting adjustment circuit 2 is turned off, the filtering capacitor EC is discharged.

The second current loop I2 passes through the high color temperature light source 25 and is output from the high color temperature output terminal Ht of the driving power source 21, and then splits into two current paths. One current path returns to the negative live wire output terminal P- of the driving power source 21 through pins P1 and P3 of the switch SW, and the other current path returns to the negative live wire output terminal P- of the driving power source 21 through pins P12 and P10 of the switch SW. The current of the second current loop I2 accounts for 98 percent of the total current.

The fourth current loop I4 passes through the low color temperature light source 24 and is output from the low color temperature output terminal Lt of the driving power source 21, passes through the first resistor unit K1, the second resistor unit K2, and the adjustment circuit 23, and then splits into two current paths. One current path returns to the negative live wire output terminal P- of the driving power source 21 through pins P1 and P3 of the switch SW, and the other current path returns to the negative live wire output terminal P- of the driving power source 21 through pins P12 and P10 of the switch SW. The current of the fourth current loop I4 accounts for 1 percent of the total current.

Similarly, when the user operates the switching circuit 22 to enter the low color temperature mode, the switching circuit 22 is switched to make the driving power source 21 form the first current loop I1 passing through the switching circuit 22, the third current loop I3 passing through the low color temperature light source 24 and the switching circuit 22, and the fourth current loop I4 passing through the high color temperature light source 25, the switching circuit 22, and the adjustment circuit 23.

The first current loop I1 is output from the positive live wire output terminal P+ of the driving power source 21 and returns to the negative live wire output terminal P- of the driving power source 21 through the stabilization unit SU (the current-consuming resistor Rs), and the filtering capacitor EC provides the filtering effect. The current of the first current loop I1 accounts for 1 percent of the total current. In addition, when the lighting adjustment circuit 2 is turned off, the filtering capacitor EC is discharged.

The third current loop I3 passes through the low color temperature light source 24 and is output from the low color temperature output terminal Lt of the driving power source 21, and then splits into two current paths. One current path returns to the negative live wire output terminal P- of the driving power source 21 through pins P7 and P10 of the switch SW, and the other current path returns to the negative live wire output terminal P- of the driving power source 21 through pins P6 and P3 of the switch SW. The current of the third current loop I3 accounts for 98 percent of the total current.

The fourth current loop I4 passes through the high color temperature light source 25 and is output from the high color temperature output terminal Ht of the driving power source 21, passes through the adjustment circuit 23, the first resistor unit K1, and the second resistor unit K2, and then splits into two current paths. One current path returns to the negative live wire output terminal P- of the driving power source 21 through pins P7 and P10 of the switch SW, and the other current path returns to the negative live wire output terminal P- of the driving power source 21 through pins P6 and P3 of the switch SW. The current of the fourth current loop I4 accounts for 1 percent of the total current.

Similarly, when the user operates the switching circuit 22 to enter the 5000K mode (the intermediate color temperature mode), the switching circuit 22 is switched to make the driving power source 21 form the first current loop I1 passing through the switching circuit 22, the second current loop I2 passing through the high color temperature light source 25 and the switching circuit 22, and the third current loop I3 passing through the low color temperature light source 24 and the switching circuit 22.

The first current loop I1 is output from the positive live wire output terminal P+ of the driving power source 21 and returns to the negative live wire output terminal P- of the driving power source 21 through the stabilization unit SU (the current-consuming resistor Rs), and the filtering capacitor EC provides the filtering effect. In addition, when the lighting adjustment circuit 2 is turned off, the filtering capacitor EC is discharged.

The second current loop I2 passes through the high color temperature light source 25 and is output from the high color temperature output terminal Ht of the driving power source 21, and then returns to the negative live wire output terminal P- of the driving power source 21 through pins P2 and P3 of the switch SW.

The third current loop I3 passes through the low color temperature light source 24 and is output from the low color temperature output terminal Lt of the driving power source 21, passes through the first resistor unit K1 and the second resistor unit K2, and finally returns to the negative live wire output terminal P- of the driving power source 21 through pins P11 and P10 of the switch SW. In the intermediate color temperature mode, no current flows through the adjustment circuit 23.

Similarly, when the user operates the switching circuit 22 to enter the 4000K mode (the intermediate color temperature mode), the switching circuit 22 is switched to make the driving power source 21 form the first current loop I1, the second current loop I2, and the third current loop I3.

The first current loop I1 is output from the positive live wire output terminal P+ of the driving power source 21 and returns to the negative live wire output terminal P- through the stabilization unit SU, and the filtering capacitor EC provides the filtering effect. In addition, when the lighting adjustment circuit 2 is turned off, the filtering capacitor EC is discharged.

The second current loop I2 passes through the high color temperature light source 25 and is output from the high color temperature output terminal Ht of the driving power source 21, passes through the fifth resistor unit K5 and the sixth resistor unit K6, and finally returns to the negative live wire output terminal P- through pins P4 and P3 of the switch SW.

The third current loop I3 passes through the low color temperature light source 24 and is output from the low color temperature output terminal Lt of the driving power source 21, passes through the third resistor unit K3 and the fourth resistor unit K4, and finally returns to the negative live wire output terminal P- through pins P9 and P10 of the switch SW. In the intermediate color temperature mode, no current flows through the adjustment circuit 23.

Similarly, when the user operates the switching circuit 22 to enter the 3500K mode (the intermediate color temperature mode), the switching circuit 22 is switched to make the driving power source 21 form the first current loop I1, the second current loop I2, and the third current loop I3.

The first current loop I1 is output from the positive live wire output terminal P+ of the driving power source 21 and returns to the negative live wire output terminal P- through the stabilization unit SU, and the filtering capacitor EC provides the filtering effect. In addition, when the lighting adjustment circuit 2 is turned off, the filtering capacitor EC is discharged.

The second current loop I2 passes through the high color temperature light source 25 and is output from the high color temperature output terminal Ht of the driving power source 21, passes through the fifth resistor unit K5, the sixth resistor unit K6, the seventh resistor unit K7, and the eighth resistor unit K8, and finally returns to the negative live wire output terminal P- through pins P5 and P3 of the switch SW.

The third current loop I3 passes through the low color temperature light source 24 and is output from the low color temperature output terminal Lt of the driving power source 21, and finally returns to the negative live wire output terminal P- through pins P8 and P10 of the switch SW. In the intermediate color temperature mode, no current flows through the adjustment circuit 23.

Other intermediate color temperature operating mechanisms are similar to those described above and therefore are not repeated herein.

Different color temperature values corresponding to different currents may be obtained through testing by changing the currents of the first current loop I1, the second current loop I2, and the third current loop I3. Accordingly, a desired color temperature can be achieved by controlling the currents of the first current loop I1, the second current loop I2, and the third current loop I3.

The circuit design of the switching circuit 22 may be varied according to actual requirements and is not limited to the circuit design of the present embodiment.

Through the above-described circuit design and switching mechanism of the switching circuit, the driving power source 21 is capable of forming three current loops to drive the low color temperature light source 24 and the high color temperature light source 25, such that the lighting adjustment circuit 2 can achieve a greater number of color temperature adjustment levels to meet the requirements of different applications. In addition, the current used to drive the low color temperature light source 24 and the high color temperature light source 25 is always less than the total current.

In addition, in the high color temperature mode, the driving power source 21 drives the high color temperature light source 25 with a majority of the current and drives the low color temperature light source 24 with a very small current. Accordingly, in the high color temperature mode, the lighting adjustment circuit 2 mainly outputs high color temperature light from the high color temperature light source 25, while low color temperature light generated by the low color temperature light source 24 is mixed with the high color temperature light to enhance special color rendering (R9) of the mixed light. Similarly, in the low color temperature mode, the driving power source 21 drives the low color temperature light source 24 with a majority of the current and drives the high color temperature light source 25 with a very small current. Accordingly, in the low color temperature mode, the lighting adjustment circuit 2 mainly outputs low color temperature light from the low color temperature light source 24, while high color temperature light generated by the high color temperature light source 25 is mixed with the low color temperature light to enhance luminous efficacy of the mixed light.

As can be understood from the above, the circuit design and the switching mechanism of the switching circuit of the lighting adjustment circuit 2 can be applied to various currently available LED lighting devices and can effectively achieve a greater number of color temperature adjustment levels. At the same time, the circuit design and the switching mechanism of the switching circuit enhance luminous efficacy and special color rendering R9 of the lighting adjustment circuit 2. Therefore, the lighting adjustment circuit 2 can be more comprehensive in application and more flexible in use.

To sum up, according to one embodiment of the disclosure, the lighting adjustment circuit includes a driving power source, a switching circuit, a low color temperature light source, and a high color temperature light source. The switching circuit is connected to the driving power source. The low color temperature light source is connected to the driving power source and the switching circuit. The high color temperature light source is connected to the driving power source and the switching circuit. The color temperature of the high color temperature light source is greater than the color temperature of the low color temperature light source. The switching circuit is switched to make the driving power source form three current loops to drive the low color temperature light source and the high color temperature light source. As described above, through the above circuit design and switching mechanism of the switching circuit, the driving power source can form three current loops to drive the low color temperature light source and the high color temperature light source, such that the lighting adjustment circuit can achieve multiple levels of color temperature adjustment to meet the requirements of different applications.

Further, according to one embodiment of the disclosure, the lighting adjustment circuit further includes an adjustment circuit. The adjustment circuit is connected to the switching circuit. The switching circuit is switched to make the driving power source in the high color temperature mode form a first current loop passing through the switching circuit, a second current loop passing through the high color temperature light source and the switching circuit, and a fourth current loop passing through the low color temperature light source, the switching circuit, and the adjustment circuit. The current of the second current loop is significantly greater than the current of the first current loop and the fourth current loop. The current of the first current loop is substantially equal to the current of the fourth current loop. The color temperature in the high color temperature mode is substantially equal to the color temperature of the high color temperature light source. Through the above circuit design and switching mechanism of the switching circuit, in the high color temperature mode, the driving power source can drive the high color temperature light source with most of the current and drive the low color temperature light source with a very small current. Accordingly, in the high color temperature mode, the lighting adjustment circuit mainly outputs high color temperature light from the high color temperature light source, while the low color temperature light generated by the low color temperature light source can be mixed with the high color temperature light to enhance the special color rendering (R9) of the mixed light.

Moreover, according to one embodiment of the disclosure, the switching circuit is switched to make the driving power source in the low color temperature mode form a first current loop passing through the switching circuit, a third current loop passing through the low color temperature light source and the switching circuit, and a fourth current loop passing through the high color temperature light source, the switching circuit, and the adjustment circuit. The current of the third current loop is significantly greater than the current of the first current loop and the fourth current loop. The current of the first current loop is substantially equal to the current of the fourth current loop. The color temperature in the low color temperature mode is substantially equal to the color temperature of the low color temperature light source. Through the above circuit design and switching mechanism of the switching circuit, in the low color temperature mode, the driving power source can drive the low color temperature light source with most of the current and drive the high color temperature light source with a very small current. Accordingly, in the low color temperature mode, the lighting adjustment circuit mainly outputs low color temperature light from the low color temperature light source, while the high color temperature light generated by the high color temperature light source can be mixed with the low color temperature light to enhance the luminous efficacy of the mixed light.

In addition, according to one embodiment of the disclosure, the circuit design and switching mechanism of the lighting adjustment circuit can be applied to various currently available LED lighting devices, and can effectively achieve more levels of color temperature adjustment. At the same time, the circuit design and switching mechanism of the lighting adjustment circuit can improve the luminous efficacy and special color rendering (R9) of the lighting adjustment circuit. Therefore, the lighting adjustment circuit can be more comprehensive in application and more flexible in use.

Furthermore, according to one embodiment of the disclosure, the lighting adjustment circuit has a simple design and can achieve the desired effects without significantly increasing cost. Therefore, the lighting adjustment circuit can achieve high practicality to meet the requirements of different applications and can comply with future development trends.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A lighting adjustment circuit, comprising:
a driving power source;
a switching circuit connected to the driving power source;
a low color temperature light source connected to the driving power source and the switching circuit; and
a high color temperature light source connected to the driving power source and the switching circuit, wherein a color temperature of the high color temperature light source is greater than a color temperature of the low color temperature light source;
wherein the switching circuit is configured to be switched, whereby the driving power source forms three current loops to drive the low color temperature light source and the high color temperature light source.

2. The lighting adjustment circuit as claimed in claim 1, wherein the switching circuit is configured to be switched to make the driving power source form a first current loop passing through the switching circuit, a second current loop passing through the high color temperature light source and the switching circuit, and a third current loop passing through the low color temperature light source and the switching circuit when the driving power source operates in an intermediate color temperature mode, wherein a current of the second current loop is substantially equal to a current of the third current loop, wherein the current of the second current loop and the current of the third current loop are substantially greater than a current of the first current loop, and wherein a color temperature of the intermediate color temperature mode is lower than the color temperature of the high color temperature light source and higher than the color temperature of the low color temperature light source.

3. The lighting adjustment circuit as claimed in claim 2, wherein the switching circuit comprises a stabilization unit comprising a current-consuming resistor and a filtering capacitor connected in parallel with each other, and the first current loop passes through the stabilization unit.

4. The lighting adjustment circuit as claimed in claim 1, further comprising an adjustment circuit connected to the switching circuit, wherein the switching circuit is configured to be switched to make the driving power source form a first current loop passing through the switching circuit, a second current loop passing through the high color temperature light source and the switching circuit, and a fourth current loop passing through the low color temperature light source, the switching circuit, and the adjustment circuit when the driving power source operates in a high color temperature mode, wherein a current of the second current loop is substantially greater than a current of the first current loop and a current of the fourth current loop, wherein the current of the first current loop is substantially equal to the current of the fourth current loop, and wherein a color temperature of the high color temperature mode is substantially equal to the color temperature of the high color temperature light source.

5. The lighting adjustment circuit as claimed in claim 4, wherein the switching circuit comprises a stabilization unit, and the stabilization unit comprises a current-consuming resistor and a filtering capacitor connected in parallel with each other, and the first current loop passes through the stabilization unit.

6. The lighting adjustment circuit as claimed in claim 1, further comprising an adjustment circuit connected to the switching circuit, wherein the switching circuit is configured to be switched to make the driving power source form a first current loop passing through the switching circuit, a third current loop passing through the low color temperature light source and the switching circuit, and a fourth current loop passing through the high color temperature light source, the switching circuit, and the adjustment circuit when the driving power source operates in a low color temperature mode, wherein a current of the third current loop is substantially greater than a current of the first current loop and a current of the fourth current loop, wherein the current of the first current loop is substantially equal to the current of the fourth current loop, and wherein a color temperature of the low color temperature mode is substantially equal to the color temperature of the low color temperature light source.

7. The lighting adjustment circuit as claimed in claim 6, wherein the switching circuit comprises a stabilization unit, and the stabilization unit comprises a current-consuming resistor and a filtering capacitor connected in parallel with each other, and the first current loop passes through the stabilization unit.

8. The lighting adjustment circuit as claimed in claim 1, wherein the low color temperature light source and the high color temperature light source are light-emitting diodes.

9. The lighting adjustment circuit as claimed in claim 1, wherein the color temperature of the high color temperature light source is from two times to three times the color temperature of the low color temperature light source.

10. The lighting adjustment circuit as claimed in claim 1, wherein the driving power source is a light-emitting diode driver.
